(19) United States
(12) Patent Application Publication
(10) Pub. No.: US 2007/0246444 A1
(43) Pub. Date: Oct. 25, 2007

(54) Contact system for an electrical switching device

(75) Inventors: David Saxl, Zurich (CH); Jadran Kostovic, Neuenhof (CH); Matthias Kudoke, Thalheim (CH)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 11/812,447

(22) Filed: Jun. 19, 2007

Related U.S. Application Data
(63) Continuation of application No. PCT/CH05/00749, filed on Dec. 14, 2005.

(30) Foreign Application Priority Data
Dec. 21, 2004 (EP) 04405788.3

(51) Int. Cl. H01H 33/12

(52) U.S. Cl. 218/16

(57) ABSTRACT

The disclosure relates to an electrical contact system for a switching device having a mating contact and a second contact. According to the invention, the second contact has a contact tulip, at the outer face of which a current transfer takes place to an annular part of the mating contact. Exemplary embodiments relate to, inter alia: additional current transfer at an inner contact-making face of the contact tulip to a pin-shaped part of the mating contact; mating contact with mating contact tulip for engaging with the contact tulip; and measures for improving the contact forces. Advantages include: tulip-in-tulip design with large contact face, high contact force, reduced number of contact fingers, reduced number of mating contact fingers, and improved adjustment tolerance; contact tulip acts as an arcing contact and at the same time as a short-term current contact.

### RELATED APPLICATIONS

This application claims priority under 35 U.S.C. §119 to EP Application 04405788.3 filed in Europe on Dec. 21, 2004, and as a continuation application under 35 U.S.C. §120 to PCT/CH2005/000749 filed as an International Application on Dec. 14, 2005, designating the U.S., the entire contents of which are hereby incorporated by reference in their entireties.

### TECHNICAL FIELD

The invention relates to the field of high-voltage engineering, in particular high-voltage breaker engineering in electrical power distribution systems. It is based on a contact system for a switching device and on a switching device.

### BACKGROUND INFORMATION

The invention is based on the prior art according to EP 0 844 631. Therein, a contact system having a moveable contact and a fixed mating contact for an electrical switching device is disclosed, in which the contact and the mating contact each have a contact tulip or a finger cage having individual, sprung contact fingers. The moveable contact comprises a rigid annular-cylindrical contact tube having an inner contact tulip, which is arranged in a recessed manner in the contact tube and moves onto the stationary contact pin of the mating contact or mating contact pin, for short. In the process, the contact fingers of the inner tulip are spread outward and therefore produce the necessary bearing force against the mating contact pin. At the same time, the rigid contact tube moves into an outer contact tulip of the mating contact and in this process spreads its contact fingers outward. An inner contact system, comprising the inner tulip of the contact and the contact pin of the mating contact, and an outer contact system which is independent thereof, comprising the contact tube of the contact and the outer tulip of the mating contact, are therefore provided. The inner contact system is used for controlling arcs, and the outer contact system is used for grounding short-circuit currents or short-term currents. This dual contact system having two contact tulips which are independent of one another corresponds to the conventional system for circuit breakers with arcing contacts and rated current contacts. In this case, the current transfer takes place in both contact tulips via the inner faces of the contact fingers, and the spreading of the inner contact fingers and the spreading of the outer contact fingers for producing the bearing forces take place mechanically and also temporally independently of one another.

DE 29 35 202 discloses a contact system for switching devices with high short-circuit currents. A rigid contact tube moves into a contact tulip and in the process spreads its contact fingers apart from one another, with the result that, in turn, a current transfer from the outer face of the contact tube to the inner faces of the contact fingers is provided. An erosion-resistant supporting sleeve is provided in the contact tulip in order to prevent the contact fingers from being welded in the arc. The supporting sleeve possibly also has ribs or pins for keeping the contact fingers apart from one another.

EP 1 068 624 has disclosed a combined disconnector and grounding switch which has a contact part which can be displaced into three positions (disconnector closed, disconnector open, grounding switch closed). In the mid-position, the contact part has been moved in a hollow-cylindrical housing part of the current path which has contact tulips on both sides for the purpose of making contact with tube sections of the contact part. At its end on the grounding-switch side, the contact part has a grounding-switch contact tulip, which is moved through the contact tulip of the housing part when the grounding switch is closed. In the process, both contact tulips are at the same potential and do not form a current transfer.

In the invention reference is made to DE 1 220 927. Therein, an electric switch is disclosed whose switching pin is a slit tube which interacts with a rigid, annular mating switching piece. A rigid body is arranged in the interior of the slit tube in order to avoid collapsing of the tube under current forces.

U.S. Pat. No. 4,628,164 likewise discloses an electrical switch having a slit switching pin which engages in a rigid contact tube, which lies further outward, of the mating contact.

### SUMMARY

The object of the present invention is to specify an alternative, simplified contact system for a switching device.

The invention consists in an electrical contact system for an electrical switching device for power supply systems, the switching device having a central axis and a first contact or mating contact and a second contact, at least the second contact comprising a contact tulip having a plurality of contact fingers, and the contact fingers having outer faces, which face away from the central axis, and inner faces, which face the central axis, in a closed operating state of the switching device the contact tulip being inserted in the first contact, in addition, in the closed operating state, the outer faces of the contact fingers of the contact tulip bearing against the first contact and forming an outer contact-making face for a current transfer to the first contact. A contact face for the current transfer is therefore provided by the contact tulip via the outer faces of its contact fingers. Owing to the current transfer via an outer face of the contact tulip, a large-area contact face or current transfer face can also be realized without any mating contact pin on the first contact. Owing to the current being drawn at the contact tulip outer face, the parallel current path in the contact fingers can be shortened even in the case of a constant penetration depth of the contact tulip in the first contact, and the electromagnetic load which can be applied can be increased. As a result, the first contact can have a very simple design, for example in the form of a rigid tube or in the form of a ring contact. Care should be taken in this case to ensure that the contact fingers have a sufficiently high spring force which is directed radially outward in order to ensure sufficient bearing force against the first contact even when the contact fingers are drawn radially inward in addition owing to electromagnetic current forces.

According to the invention, in the closed operating state the inner faces of the contact fingers of the contact tulip also bear against the first contact and form an inner contact-making face for a further current transfer to the first contact. Owing to the combination of two current transfers, a very large contact-making face between the first and the second contact can be provided.

An exemplary embodiment can have the advantage that separate arcing contacts are provided for the switching device, with the result that the current transfer can take place via the outer contact-making face without any arc erosion.

In a further form of the invention, the first contact has a mating contact tulip having a plurality of mating contact fingers, and in a closed operating state of the switching device the contact fingers of the contact tulip and the mating contact fingers come into touching contact with one another and form a common contact face for the current transfer or the further current transfer. Owing to such a tulip-in-tulip design, a cost-effective and make-proof or operationally reliable grounding contact can be constructed. In particular, the number of contact fingers per tulip can be reduced. The contact tulip transfers at its contact finger caps the arc and laterally at its circumference the short-term current or short-circuit current. These two functions have previously been performed separately by different components in the prior art. The tulip-in-tulip design can also be realized in a circuit breaker, the contact tulip in turn transferring at its contact finger caps the arc and laterally at its circumference the operating current, short-term current or short-circuit current.

In an advantageous configuration, the mating contact tulip engages around the contact tulip from the outside, and the common contact face is formed by the outer faces of the contact fingers and by inner faces of the mating contact fingers. In this case, the common tulip-tulip contact face is advantageously used for the current transfer at high short-term currents or short-circuit currents or possibly operating currents.

In a further advantageous configuration, the mating contact fingers are spread apart when the contact tulip is moved into the mating contact tulip in order to produce a first bearing force of the mating contact fingers against the contact fingers; and/or the contact fingers are compressed when the contact tulip is moved into the mating contact tulip in order to produce the reactive first bearing force of the contact fingers against the mating contact fingers. Owing to the interaction between the elastic spring response of the contact fingers and of the mating contact fingers, a contact system is provided which is very flexible and tolerant to adjustments, but is nevertheless reliable. In particular, contact tulips having different spring-deflection characteristics can be combined easily since the softer contact tulip matches itself easily to the harder contact tulip. The tulip-in-tulip design also allows for relatively large mechanical tolerances when aligning the contacts and during operation in the case of misadjustments owing to thermal loads or electromagnetic current forces.

In accordance with a further important exemplary embodiment, the first contact comprises a tubular contact part, in particular the mating contact tulip, and an inner mating contact pin, the contact tulip moving into the tubular contact part and onto the mating contact pin when the switching device is closed. Advantageously, the contact fingers of the contact tulip are spread apart when it is moved onto the mating contact pin in order to produce a further first bearing force of the contact fingers against the tubular contact part, in particular against the mating contact fingers, and furthermore in order to produce a second bearing force of the contact fingers against the mating contact pin. In this configuration, the contact tulip therefore moves into the mating contact tulip and at the same time onto the mating contact pin. As a result, a high contact force of the contact fingers against the outer faces toward the mating contact fingers and against the inner faces toward the mating contact pin is achieved. In particular, the outer mating contact tulip with its contact-pressure force increases the contact-pressure force of the contact tulip against the mating contact pin. Owing to the high contact forces or bearing forces and the large contact faces, the transfer resistance is reduced in comparison with conventional arrangements and the current-carrying capacity is increased.

Further measures are disclosed for improving the contact force between the first and second contact and in particular the combined contact-pressure forces of the contact tulip and the mating contact tulip.

An exemplary electrical switching device can have an electrical contact system as described above and can have the advantages mentioned there.

Further exemplary embodiments, advantages and applications of the disclosure are given in the following description and figures.

### BRIEF DESCRIPTION OF THE DRAWINGS

In the drawings:

FIG. 1 shows, schematically, a first exemplary embodiment of the invention having a contact tulip making contact on the outside and an optional mating contact pin; and

FIG. 2 shows, schematically, a second exemplary embodiment of the invention having a contact tulip and a mating contact tulip.

In the figures, the same parts have been provided with the same reference symbols.

### DETAILED DESCRIPTION

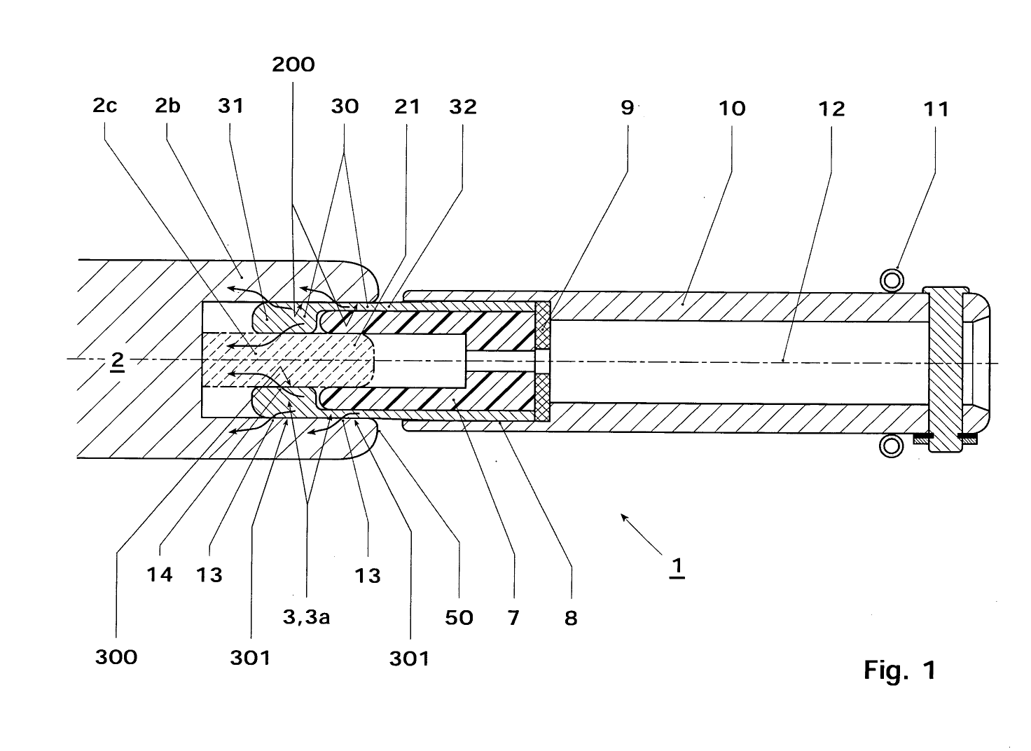

FIG. 1 shows a contact region of an electrical switching device. The electrical contact system 1 comprises a first contact or mating contact 2 and a second contact 3, which are typically arranged concentrically with respect to a central axis 12. The second contact 3 comprises a contact tulip 3a, whose contact fingers 30 have inner faces 300, which point substantially radially inward with respect to the axis 12, and outer faces 301, which point substantially radially outward with respect to the axis 12. In the simplest case, the first contact 2 comprises a rigid contact tube 2b and optionally also a mating contact pin 2c (illustrated by dashed lines) arranged concentrically therein. According to the invention, in the closed operating state of the switching device illustrated, the outer faces 301 of the contact fingers 30 of the contact tulip 3a bear against the first contact 2 and form an outer contact-making face 301 for a current transfer 13 to the first contact 2, namely the contact tube or ring contact 2b. The bearing force of the contact fingers 30 against the first contact 2 can be produced, for example, by compressing or spreading apart the contact tulip 3a or possibly by other means.

Advantageously, the contact fingers 30 are designed to have an inward spring deflection. In order to increase the spring force, additional compression springs can be fitted on the inside in the contact tulip 3a, which compression springs exert a contact-pressure force on the contact fingers 30 which is directed away from the central axis 12, i.e. is directed substantially radially outward. It is also necessary to take care that the outwardly directed first bearing force of the contact fingers 30 against the first contact 2 is sufficient on the outer contact-making face 301 to ensure that the contact fingers 30 also at any time absorb and overcompensate for current forces drawing them inward even in the state in which they have an inward spring deflection, with the result that, at any time, a sufficient first contact force and therefore a sufficiently low-resistance current transfer 13 is ensured at the outer contact-making face 301.

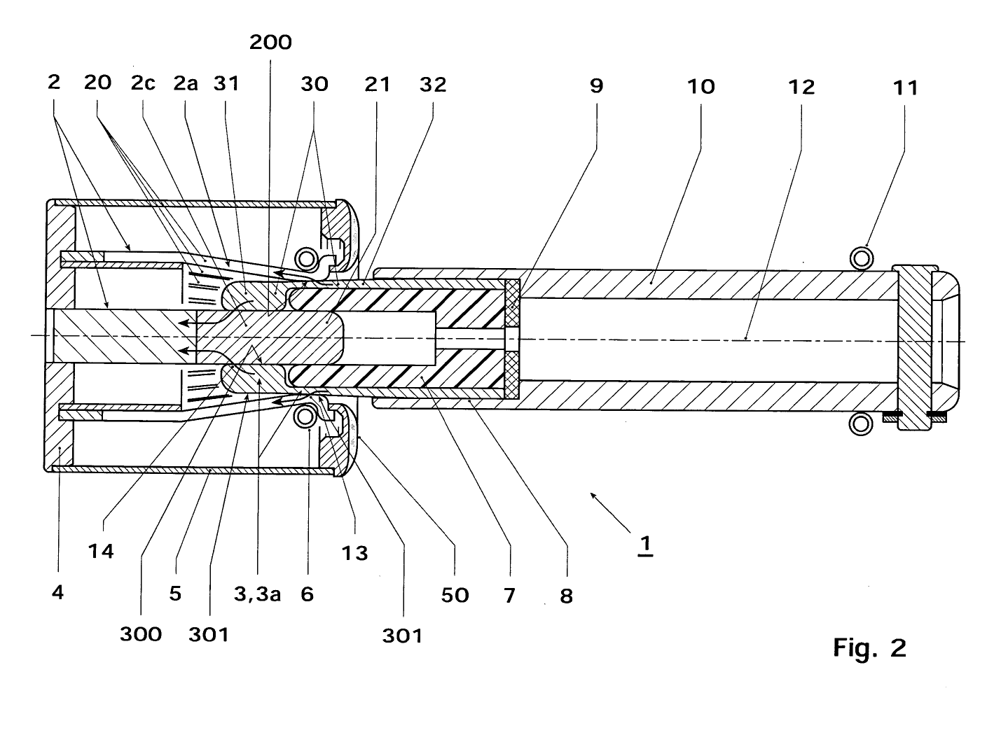

In an advantageous embodiment, the first contact 2 comprises a contact inner part 2c, which, when the switch is closed or in the closed operating state, also makes electrical contact with the inner faces 300 of the contact fingers 30 of the contact tulip 3a and, via this inner contact-making face 300, forms a further current transfer 14 to the first contact 2. The contact inner part 2c is preferably the rigid mating contact pin 2c illustrated in FIGS. 1 and 2, but could also be an inner tulip 2c. In this way, at least one first current-conducting operating state of the switching device is provided in which the contact fingers 30 of the contact tulip 3a have a current transfer 13 at their outer face 301, for example for short-term current in a grounding switch, and a further current transfer 14 at their inner face 300, for example for an arcing current. The two operating states can occur simultaneously and are encompassed by the term “closed operating state” of the switching device. The closed operating state is also understood to include closing operations and includes at least one such operating state in which current is transferred or can be transferred through the contact system 1, such as, for example, a pre-arcing phase, arcing phase, contact phase for current transfer 13, 14 or a state in which the contacts 2, 3 have been moved in completely.

Given the presence of the inner, preferably pin-shaped mating contact 2c, an arcing current can be transferred during a closing operation of the switching device between the contact tulip 3a, in particular the contact finger caps 31 of the contact fingers 30, and the pin 2c. The contact finger caps 31 therefore form arcing contacts 31, 2c of the switching device on the contact tulip 3a together with the mating contact pin 2c. When the contacts 2, 3 are moved in, the inner mating contact 2c preferably serves the purpose of providing the above-described current transfer 14 via the inner faces 300 of the contact fingers 30 of the contact tulip 3a. The mechanical function of the inner mating contact 2c consists in the contact fingers 30 of the contact tulip 3a being spread apart from one another when said contact tulip 3a is moved onto the mating contact pin and, as a result, a further first bearing force of the contact fingers 30 against the tubular contact part 2b, in particular against a mating contact tulip 2a as shown in FIG. 2, being produced and, furthermore, a second bearing force of the contact fingers 30 against the inner mating contact 2c itself being produced.

In the embodiment with the inner mating contact 2c, the contact tulip 3a takes on three different functions, namely, at the beginning of the closing operation, arcing contact at the contact finger caps 31 and, when it is moved in, transfer of high and very high currents 13, 14 at the contact finger outer faces 301 and at the contact finger inner faces 300. The contact tulip 3a therefore acts, depending on the type of switch, as an arcing contact 31 (grounding switch, disconnector, circuit breaker) and at the same time as a short-circuit current contact 300, 301 or short-term current contact 300, 301 (grounding switch, disconnector, circuit breaker) or rated current contact 300, 301 (disconnector, circuit breaker). In particular, the outer contact-making face 301 of the contact tulip 3a transfers a short-term current of up to 63 kA over 3 s, and/or a surge current, in particular up to 170 kA. Included in the type of switching devices are: fast-acting grounding switch, combined disconnector and grounding switch, switcher and other possible variants of power distribution switching devices. The switching device is typically arranged in a dead tank breaker (DTB), in an encapsulated gas-insulated switchgear assembly (GIS) or in a life tank breaker (LTB).

FIG. 2 shows a preferred exemplary embodiment, in which the contact tulip 3a has a similar design to that in FIG. 1 and, in addition, the first contact 2 has a further contact tulip 2a, in this case referred to as the mating contact tulip 2a. The mating contact or mating contact pin 2c also performs the same functions here as discussed previously and could also be in the form of a tulip. The first contact 2 therefore has a mating contact pin 2c onto which the contact tulip 3a is moved and a mating contact tulip 2a into which the contact tulip 3a is moved.

The contact tulips 3a, 2a and possibly 2c are also referred to as finger cages and have a plurality of contact fingers 20, 30, which are typically arranged cylindrically and which can be sprung-in individually and relatively independently of one another. The spring deflection can take place inward towards the axis 12 by the contact fingers 30 being compressed (for example by the mating contact tulip 2a) or outwardly away from the axis 12 by the mating contact fingers 20 being spread apart (for example by the contact tulip 3a) or the contact fingers 30 being spread apart (for example by the mating contact pin 2c). The contact tulips 3a, 2a and possibly 2c can be produced from a slit tube. A contact tulip should have at least two contact fingers, which are sufficiently flexible radially and, in particular, can be spread. Owing to the tulip-in-tulip design, the number of contact fingers 30, 20 can be reduced and in particular be halved on any of the participating contact tulips 3a, 2a. The number of mating contact fingers 20 could therefore be reduced from 44 to 24 on the mating contact tulip 2a without any performance losses in tests with a short-term current of 63 kA and a surge current of 170 kA. Even six contact fingers may be sufficient on the contact tulip 3a for ensuring the desired current-carrying capacity at the current transfers 13, 14.

At least one of the contacts 2, 3 should be capable of moving. For example, drive means for moving the second contact 3 axially and in particular for moving its contact tulip 3a into the first contact 2 are provided. The first contact 2 itself may be stationary or moveable. A twin movement of the two contacts 2, 3 or other forms of contact movement are also possible. In general, the invention does not represent any restriction in terms of the movement of the first and second contacts 2, 3.

In the text which follows, a few design details are discussed with respect to the contact tulip 3a with which contact can be made from the outside (FIGS. 1, 2) and with respect to the mating contact tulip 2a, with which contact can be made from the inside (FIG. 2).

A supporting sleeve 7 can be arranged in the contact tulip 3a. Advantageously, the supporting sleeve 7 is cylindrical and is inserted or fitted concentrically into the contact finger tulip 3a. The inner sides of the contact fingers 30 bear against the supporting sleeve 7. The sleeve 7 in particular supports the contact fingers 30 in the region of the contact finger necks 32 and leaves space at the tulip opening for the contact finger caps 31. The supporting sleeve 7 serves the purpose of preventing the contact tulip 3a or its contact fingers 30 from collapsing under current forces and of keeping the contact tulip 3a in a centered position even in the event of asymmetric current forces, caused by electromagnetic transverse forces, in order to ensure a symmetrical contact force of all contact fingers 30. Advantageously, the supporting sleeve 7 contains Teflon and in particular a proportion of glass fibers. The glass fiber content may be, for example, up to a maximum of 25%. The supporting sleeve 7 may also be manufactured from metal.

The contact tulip 3a is provided with an outer thread 8 advantageously in the region of the tulip bottom, i.e. in a base region of the contact fingers 30, for the purpose of screwing the contact tulip 3a into a bearing tube 10. The bearing tube 10 serves the purpose of transferring current and has spiral contact springs 11 at the other end for drawing current to a current path (no longer illustrated). The contact tulip 3a shall be fixed to the tulip bottom on a fixing plate 9. For example, a fixing plate 9 made from copper (Cu) can be screwed to a bearing tube 10 made from aluminum (Al). Advantageously, a fixing plate or bottom plate 9 of copper is connected to a bearing tube 10, likewise of copper, by means of electric welding. As a result, the contact transfer resistance from the contact tulip 3a to the bearing tube 10 can be reduced considerably.

The mating contact tulip 2a is for its part fixed to a base plate 4 and surrounded concentrically by a holding tube 5. The holding tube 5 is surrounded in the opening pr mouth region of the first contact 2 by an erosion-resistant cap 50. The cap 50 acts as protection against arc erosion and as dielectric shielding of the contact system 1, in particular of the mating contact tulip 2a and, in the moved-in operating state, also of the contact tulip 3a. The shielding cap 50, the mating contact pin cap 21 and the contact finger cap 31 consist of or contain particularly erosion-resistant material, such as a tungsten/copper (WCu) alloy, for example. The caps 50, 21, 31 may have copper cast behind them. The contact fingers 30 and/or the mating contact fingers 20 consist of or contain preferably a copper/chromium/zirconium (CuCrZr) alloy for achieving a high spring force with, at the same time, a high electrical conductivity.

In order to increase the first bearing force of the contact fingers 30 against the mating contact fingers 20 and/or in order to increase the second bearing force of the contact fingers 30 against the mating contact pin 2c, the contact tulip 3a can be widened when looking from the contact finger caps 31 towards the contact finger necks 32, with the result that the contact tulip 3a is capable of being progressively compressed when it is moved into the tubular contact part 2b (FIG. 1) or into the mating contact tulip 2a (FIG. 2). The mating contact tulip 2a may also have a contact spring 6 engaging around it in order to compress the mating contact fingers 20.

The subject matter of the invention is also an electrical switching device for a power supply system, in particular a grounding switch, a fast-acting grounding switch, a disconnector or a circuit breaker, which has the above-described electrical contact system 1.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Electrical contact system

2 First contact, fixed contact, tulip/pin contact, current path contact, mating contact

2a First contact tulip, mating contact tulip

2b Contact tube, ring contact

2c Inner mating contact, mating contact pin, arcing contact

20 First contact fingers, mating contact fingers

200 Inner faces of first contact or of first contact fingers

21 Mating contact finger cap, erosion-resistant cap, WCu cap

3 Second contact, running contact, tulip contact, grounding contact

3a Second contact tulip, contact tulip

30 Second contact fingers, running contact fingers

300 Inner face of contact fingers

301 Outer face of contact fingers

31 Contact finger cap, erosion-resistant cap, WCu cap (for running contact fingers)

32 Contact finger neck (for running contact fingers), CuCrZr

4 Fixing plate, base plate

5 Holding tube

50 Shielding cap, erosion-resistant cap, WCu cap (for holding tube)

6 Contact spring

7 Supporting sleeve, Teflon glass sleeve

8 Screw-in thread (for contact tulip)

9 Fixing plate, Cu plate

10 Bearing tube, aluminum tube

11 Spiral contacts

12 Central axis, axis of symmetry

13 Current transfer to outer face of contact tulip

14 Current transfer to inner face of contact tulip

What is claimed is:

1. An electrical contact system for an electrical switching device for power supply systems, in particular for a fast-acting grounding switch or a circuit breaker, the switching device having a central axis and a first contact or mating contact and a second contact, at least the second contact comprising a contact tulip having a plurality of contact fingers, and the contact fingers having outer faces, which face away from the central axis, and inner faces, which face towards the central axis, in a closed operating state of the switching device the contact tulip being inserted in the first contact, in addition, in the closed operating state, the outer faces of the contact fingers of the contact tulip bearing against the first contact and forming an outer contact-making face for a current transfer to the first contact, wherein in the closed operating state the inner faces of the contact fingers of the contact tulip also bear against the first contact and form an inner contact-making face for a further current transfer to the first contact.

2. The electrical contact system as claimed in claim 1, wherein contact finger caps on the contact tulip, together with an inner mating contact of the first contact, in particular an inner tulip, form arcing contacts of the switching device.

3. The electrical contact system as claimed in claim 1, wherein
a) the first contact has a mating contact tulip having a plurality of mating contact fingers, and
b) in a closed operating state of the switching device the contact fingers of the contact tulip and the mating contact fingers come into touching contact with one another and form a common contact face for the current transfer or the further current transfer.

4. The electrical contact system as claimed in claim 3, wherein in the closed operating state of the switching device
a) the mating contact tulip engages around the contact tulip from the outside, and
b) the common contact face is formed by the outer faces of the contact fingers and by inner faces of the mating contact fingers.

5. The electrical contact system as claimed in claim 3, wherein, in order to produce a first bearing force of the mating contact fingers against the contact fingers,
a) the mating contact fingers are spread apart when the contact tulip is moved into the mating contact tulip and/or
b) the contact fingers are compressed when the contact tulip is moved into the mating contact tulip.

6. The electrical contact system as claimed in claim 3, wherein the first contact comprises a tubular contact part, including the mating contact tulip, and an inner mating contact pin, the contact tulip moving into the tubular contact part and onto the mating contact pin when the switching device is closed.

7. The electrical contact system as claimed in claim 6, wherein the contact fingers of the contact tulip are spread apart when it is moved onto the mating contact pin in order to produce a further first bearing force of the contact fingers against the tubular contact part, in particular against the mating contact fingers, and in order to produce a second bearing force of the contact fingers against the mating contact pin.

8. The electrical contact system as claimed in claim 5, wherein, in order to increase the first bearing force of the contact fingers against the mating contact fingers and/or in order to increase the second bearing force of the contact fingers against the mating contact pin,
a) the contact tulip becomes wider when looking from the contact finger caps towards the contact finger necks, with the result that the contact tulip is capable of being progressively compressed when it is moved into the tubular contact part or the mating contact tulip and/or
b) the mating contact tulip has a contact spring engaging around it in order to compress the mating contact fingers.

9. The electrical contact system as claimed in claim 1, wherein
a) the contact tulip has a supporting sleeve to prevent the contact tulip from collapsing under current forces and in order to keep the contact tulip in a centered position even in the event of asymmetric current forces, and
b) wherein the supporting sleeve contains Teflon and preferably a proportion of glass fibers.

10. The electrical contact system as claimed in claim 1, wherein
a) the switching device is a grounding switch, a fast-acting grounding switch, a disconnector or circuit breaker, and/or
b) the outer contact-making face of the contact tulip transfers a short-circuit current, a short-term current, in particular up to 63 kA over 3 s, and/or a surge current, in particular up to 170 kA.

11. An electrical contact system for an electrical switching device for power supply systems, in particular for a fast-acting grounding switch or a circuit breaker, the switching device having a central axis and a first contact or mating contact and a second contact, at least the second contact comprising a contact tulip having a plurality of contact fingers, and the contact fingers having outer faces, which face away from the central axis, and inner faces, which face towards the central axis, in a closed operating state of the switching device the contact tulip being inserted in the first contact, in addition, in the closed operating state, the outer faces of the contact fingers of the contact tulip bearing against the first contact and forming an outer contact-making face for a current transfer to the first contact, wherein the first contact has a mating contact tulip having a plurality of mating contact fingers and in a closed operating state of the switching device the contact fingers of the contact tulip and the mating contact fingers come into touching contact with one another and form a common contact face for the current transfer or a further current transfer.

12. The electrical contact system as claimed in claim 11, wherein in the closed operating state of the switching device
a) the mating contact tulip engages around the contact tulip from the outside, and
b) the common contact face is formed by the outer faces of the contact fingers and by inner faces of the mating contact fingers.

13. An electrical switching device for a power supply system, in particular grounding switch, fast-acting grounding switch, disconnector or circuit breaker, characterized by an electrical contact system as claimed in claim 1.

14. The electrical contact system as claimed in claim 7, wherein, in order to increase the first bearing force of the contact fingers against the mating contact fingers and/or in order to increase the second bearing force of the contact fingers against the mating contact pin,
a) the contact tulip becomes wider when looking from the contact finger caps towards the contact finger necks, with the result that the contact tulip is capable of being progressively compressed when it is moved into the tubular contact part or the mating contact tulip and/or
b) the mating contact tulip has a contact spring engaging around it in order to compress the mating contact fingers.

15. The electrical contact system as claimed in claim 8, wherein
a) the contact tulip has a supporting sleeve to prevent the contact tulip from collapsing under current forces and in order to keep the contact tulip in a centered position even in the event of asymmetric current forces, and
b) wherein the supporting sleeve contains Teflon and preferably a proportion of glass fibers.

16. The electrical contact system as claimed in claim 9, wherein
a) the switching device is a grounding switch, a fast-acting grounding switch, a disconnector or circuit breaker, and/or
b) the outer contact-making face of the contact tulip transfers a short-circuit current, a short-term current, in particular up to 63 kA over 3 s, and/or a surge current, in particular up to 170 kA.

17. An electrical switching device for a power supply system, in particular grounding switch, fast-acting grounding switch, disconnector or circuit breaker, characterized by an electrical contact system as claimed in claim 11.
